(19) United States
(12) Patent Application Publication
(10) Pub. No.: US 2009/0027592 A1
(43) Pub. Date: Jan. 29, 2009

(54) Display device, manufacturing method of display device, and manufacturing apparatus for the same

(75) Inventor: Toshihiko Motomatsu, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 12/216,796

(22) Filed: Jul. 10, 2008

(30) Foreign Application Priority Data
Jul. 25, 2007 (JP) 193596/2007

(51) Int. Cl. G02F 1/1339; G02F 1/1333; G02F 1/1335

(52) U.S. Cl. 349/64; 349/77; 445/25

(57) ABSTRACT

A display device includes a first display device, a second display device bonded to the first display device, and an adhesive provided between the first display device and the second display device to fix the first display device on the second display device, and including a light diffusion particle.

This application is based upon and claims the benefit of priority from Japanese Patent Application No. 2007-193596, filed on Jul. 25, 2007, the disclosure of which is incorporated herein in its entirety by reference.

### TECHNICAL FIELD

The present invention relates to a display device, a manufacturing method and a manufacturing apparatus thereof.

### BACKGROUND ART

FIG. 11 is a cross sectional view of a liquid crystal display (LCD) device of the related art. The LCD device 40 includes a first LCD panel 41, a second LCD panel 42 and a backlight source 46. Each of the first and the second LCD panels 41 and 42 includes a pair of transparent substrates 45 facing each other at a predetermined interval and a pair of polarizing plates 44. A liquid crystal material 43 is interposed between the transparent substrates. Each of the pair of polarizing plates 44 is arranged on an opposite side of the liquid crystal material 43 on the pair of transparent substrates. JP-2004-294824 discloses an LCD panel in which a twisted nematic (TN) liquid crystal is enclosed in the first and the second LCD panels 41 and 42. JP-11-95246 discloses adhering by a transparent adhesive for bonding liquid crystal display panels.

FIG. 12 is another cross sectional view of an LCD device of the related art. Each of a first LCD panel 51 and a second LCD panel 52 of an LCD device 50 includes a pair of transparent substrates 57 facing each other at a predetermined interval. A liquid crystal material 53 is interposed between the transparent substrates 57. The first LCD panel 51 includes a light shielding portion such as a pixel electrode 54 therein. The second LCD panel 52 includes a light shielding portion such as a reflection electrode 56. The first LCD panel 51 and the second LCD panel 52 are bonded with a transparent adhesive. A transparent adhesive 55 is formed between bonded surfaces of the panels. Generally, the first and the second liquid crystal display panels are bonded by using an ultraviolet (UV) light curing adhesive which is cured by UV light, or using a thermosetting adhesive. JP-2006-244978 discloses that an LCD panel having a light shielding member is formed by using a UV light delay curing adhesive.

FIG. 13 is a flow chart showing a process of bonding two or more LCD panels of the related art. A UV light curing adhesive of predetermined amount is applied on a surface of a second LCD panel in an adhesive applying step (S1301). In a panel assembly step (S1302), an alignment (S1303) of a first LCD panel and the second LCD panel is performed, and the first LCD panel and the second LCD panel are bonded to each other (S1304). Next, in order to temporarily fix the laminated LCD panel, a specified position of the adhesive is temporarily cured by partial UV irradiation (S1305). After that, in a UV light curing step, by UV irradiation with a predetermined amount, the adhesive is cured finally (S1306).

A hybrid type (UV and thermal curing) adhesive which is UV light curable and thermally curable may be used for an adhesive. In this case, a thermal curing step is added to a UV light curing step (S1306). In a UV light curing process, a whole adhesive is cured by UV irradiation with a predetermined amount. In a thermal curing process, the adhesive is finally cured for a long time at a temperature which does not influence a resin, such as a polarizing plate.

### SUMMARY

An exemplary object of the present invention is to provide a display device with high contrast which improves a display quality level and reliability, a manufacturing method thereof, a manufacturing apparatus for the same, and specifically to provide an LCD device, manufacturing method and a manufacturing apparatus for the same.

A display device according to an exemplary aspect of the invention includes a first display device, a second display device bonded to the first display device, and an adhesive provided between the first display device and the second display device to fix the first display device on the second display device, and including a light diffusion particle.

A manufacturing method of a display device according to an exemplary aspect the invention includes bonding a first display device with a second display device disposing an adhesive therebetween, and curing the adhesive by ultraviolet (UV) light irradiation, the adhesive including a light diffusion particle.

A dispenser device for applying an adhesive including an ultraviolet light delay curing resin according to an exemplary aspect of the invention includes a storing container to store the adhesive, an application head to store the adhesive transferred from the storing container, an ultraviolet (UV) light irradiation lamp to irradiate the ultraviolet (UV) light to the adhesive stored in the application head, and a nozzle to eject and applying the adhesive irradiated with the ultraviolet (UV) light.

### BRIEF DESCRIPTION OF THE DRAWINGS

Exemplary features and advantages of the present invention will become apparent from the following detailed description when taken with the accompanying drawings in which:

FIG. 1 is a cross sectional view of an LCD device of a first exemplary embodiment;

FIGS. 2A to 2C typically show shape of light diffusion particles of the first exemplary embodiment;

FIG. 3 is a process flow chart of assembling LCD panels in the first exemplary embodiment;

FIGS. 4A to 4D show examples of applied adhesive shapes;

FIG. 5 is a cross sectional view of an LCD device of a second exemplary embodiment;

FIG. 6 is a process flow chart of assembling LCD panels of the second exemplary embodiment;

FIG. 7 shows a relation between viscosity of a UV light delay curing adhesive and an elapsed time after UV irradiation;

FIG. 8 is a cross sectional view of an LCD device of a third exemplary embodiment;

FIG. 9 is a flow chart of assembling LCD panels of the third exemplary embodiment;

FIG. 10 shows an example of a dispenser device for the UV light delay curing adhesive;

FIG. 11 is a cross sectional view of an LCD device of the related art;

FIG. 12 is another cross sectional views of the LCD device of the related art; and

FIG. 13 is a flow chart of assembling steps of an LCD panel of the related art.

### EXEMPLARY EMBODIMENT

Next, a detailed explanation will be given for a first exemplary embodiment with reference to the drawings.

An object of the present invention is to considerably improve contrast ratio of an LCD device. In following examples, an ultraviolet (UV) light curing adhesive including light diffusion particles is filled between LCD panels and the panels are fixed, when bonding a plurality of liquid crystal display panels. As a result, even if the panels are partially shielded by a black matrix (BM), a polarizing plate, or the like, accurate, uniform and firm bonding is possible. Deterioration of display quality level such as the moiré phenomenon is prevented. Hereinafter, embodiments are described with reference to drawings.

### First Exemplary Embodiment

In order to substantially improve contrast ratio of an LCD device, a technique of piling up two or more LCD panels has been known. A black brightness level of an LCD device decreases due to the lamination structure, and contrast ratio thereof improves.

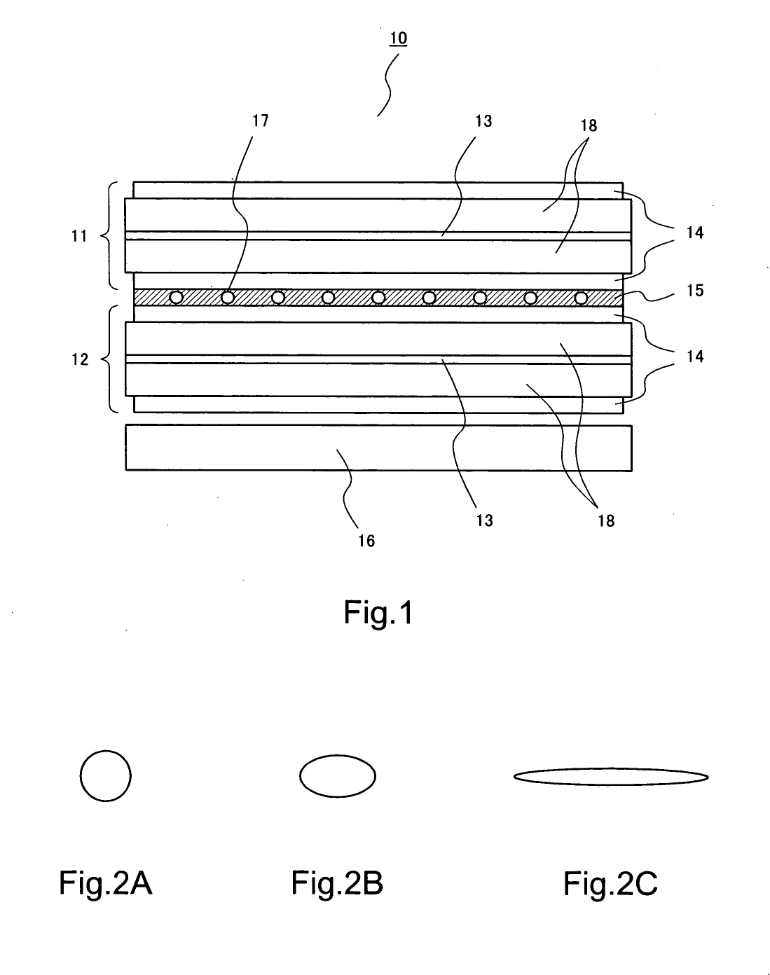

FIG. 1 is a cross sectional view of an LCD device of a first exemplary embodiment. An LCD device 10 includes a first liquid crystal display panel 11, a second liquid crystal display panel 12 and a backlight source 16. Each of the first and the second LCD panels 11 and 12 includes a pair of transparent substrates 18 facing each other at a predetermined interval and a pair of polarizing plates 14. A liquid crystal material 13 is interposed between the transparent substrates. The pair of polarizing plates 14 is arranged on opposite sides of the liquid crystal material 13 on the pair of transparent substrates 18. The first and the second LCD panels 11 and 12 are bonded to each other by using a UV light curing adhesive 15. The UV light curing adhesive 15 includes light diffusion particles 17. At least one of the first and the second LCD panels 11 and 12 may include a color filter layer for color display. An IPS (In Plane Switching) type is also applicable as a display mode of the first and second LCD panel 11 and 12. The backlight source 16 is a display light source for the LCD device 10. The first and the second LCD panels 11 and 12 are bonded so that a position of a pixel on the first LCD panel is fitted to a position of a corresponding pixel on the second LCD panel in a normal direction of the panels. A light transmission axis or a light absorption axis of the polarizing plate on a light incident side (i.e. a side facing the second LCD panel 12) of the first LCD panel 11 has to be substantially parallel to the light transmission axis or the light absorption axis of the polarizing plate on the light emission side (i.e. a side facing the first LCD panel 11) of the second LCD panel 12. Display operations of the first and the second LCD panels 11 and 12 are controlled based on the same image data.

The light diffusion particles 17 have a function for uniformly diffusing light. The light diffusion particles include polymer material mainly having methyl methacrylate polymer. The material is highly transparent and includes excellent thermal characteristics and high mechanical strength. The UV light curing adhesive 15 including the light diffusion particles forms a light diffusion layer. The light diffusion particles diffuse lights emitted from the backlight source 16 and passed through the second LCD panel 12. The diffused light enters the first LCD panel 11. As a result, the panels are uniformly bonded each other, and high contrast ratio is obtained. Interference produced between the laminated LCD panels in an oblique view may degrade display quality. Such interference is known as moiré phenomenon. The light diffusion particles prevent the moiré phenomenon. In the step of the UV light irradiation after bonding the LCD panels in the manufacturing process of the laminated LCD panel, the UV light is irradiated everywhere in the whole adhesive because of this light diffusion effect of the light diffusion particles. The light diffusion particles may function as a spacer member to keep a gap between the LCD panels constant and thin.

As the light diffusion particles 17, as shown in FIG. 2A, spherical particles may be used. As shown in FIGS. 2B and 2C, an ellipsoidal or a needle-like particle may be used. In particular, when the ellipsoidal and the needle-like particles are used, optical diffusion effect having directivity is obtained. Thereby, the irradiation and the diffusion of the UV light are controlled more effectively. Smaller variation in diameter of each of the light diffusion particles 17 is desirable. When an appropriate value for the diameter is selected, a light diffusion layer having desired thickness can be formed between the LCD panels. As a result, a uniformity of the gap in all the display surface area between the LCD panels is improved. Thus, the display quality of the laminated LCD panel is improved. Since the gap between the LCD panels becomes uniform, the light diffusion particles 17 diffuse lights more uniformly, and a deterioration of display quality due to the moiré phenomenon is suppressed. In a process of bonding the LCD panels, the light diffusion particles 17 may work as a lubricant. Thereby, position adjustment of LCD panels can be easily performed, while keeping the gap between the LCD panels uniform.

The light diffusion particles 17 are added to the UV light curing adhesive 15 shown in FIG. 1, as follows. A predetermined amount of the light diffusion particles 17 are added to the UV light curing adhesive 15 before application. After that, the UV light curing adhesive 15 is stirred and degassed in vacuum. The light diffusion particles 17 must be distributed in the adhesive 15. Thus, a mean particle diameter of the light diffusion particle 17 desirably ranges from 2 to 50 micrometers. It is necessary to keep sufficient light transmittance of the adhesive 15, while maintaining light diffusion effect of the light diffusion particles 17, and the uniform gap between LCD panels. Thus, a preferable additive amount of the light diffusion particles 17 ranges from 1 to 10 weight percent of the adhesive 15.

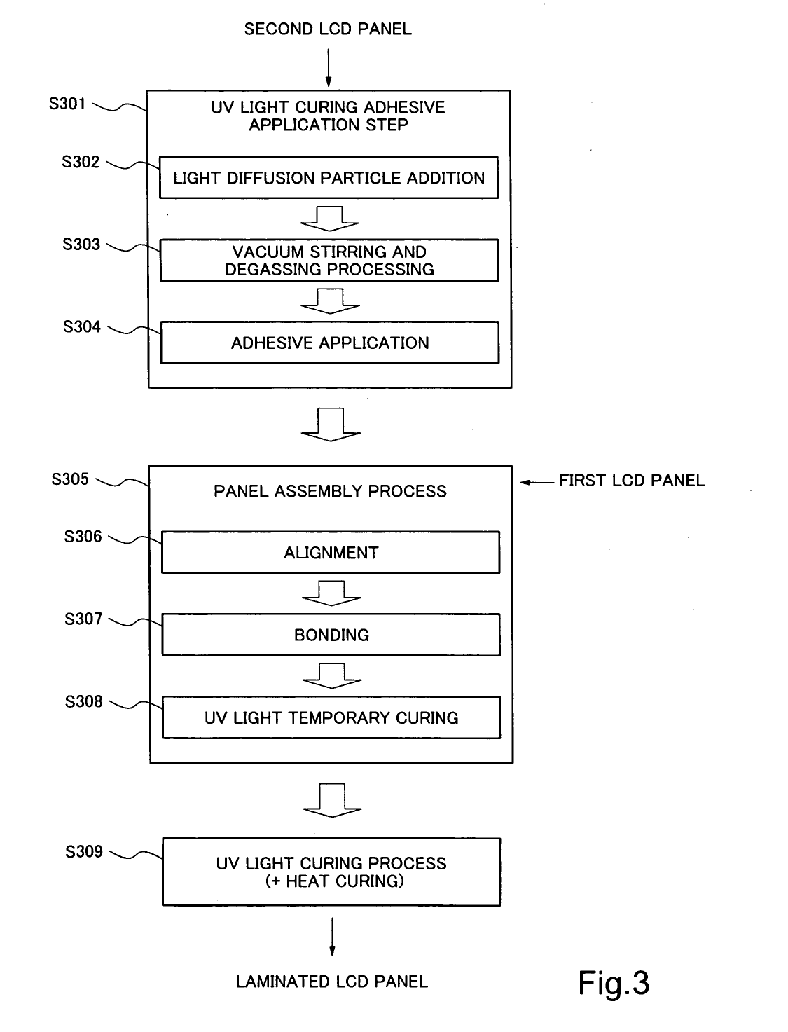

The exemplary embodiment provides a manufacturing method using the adhesive 15 including the light diffusion particles 17 and provides an LCD device having the laminated LCD panels made by using the method. FIG. 3 shows a flow chart of an exemplary process for bonding two or more LCD panels in the exemplary embodiment.

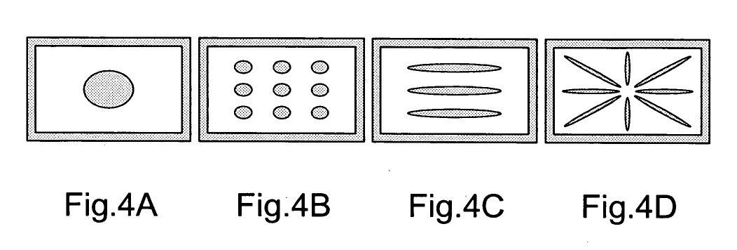

In an application step of a UV light curing adhesive (S301) in FIG. 3, a predetermined amount of light diffusion particles are added to the UV light curing adhesive before application (S302). Next, a stirring and degassing process is performed in vacuum (S303). Thereby, the light diffusion particles are distributed uniformly in the adhesive. Next, a predetermined amount of the adhesive is applied on a surface of the second LCD panel (S304). An amount of the adhesive to be applied is determined according to an area of the LCD panel surface in which the adhesive spreads. Viscosity of the adhesive applied on the display surface is not limited to this, but in view of spreading of the adhesive, the viscosity is desirably no more than 5000 mPa second. Further, in view of application stability thereof, more desirable viscosity is 100 to 1000 mPa second. When the viscosity of the adhesive is larger than 5000 mPa second, the adhesive tends to non-uniformly spread. If the viscosity thereof is smaller than 100 mPa second, it becomes difficult to apply the adhesive in a desired shape. FIGS. 4A to 4D show examples of the application shape of the adhesive in the exemplary embodiment. The adhesive is applied on a display surface in a spherical shape (FIG. 4A), a dotted shape (FIG. 4B), a line (FIG. 4C), or a radial shape (FIG. 4D). According to size of the LCD panel, appropriate application shape is selected.

Next, in an assembly step (S305) in FIG. 3, an alignment process of a first LCD panel and a second LCD panel is performed under atmosphere pressure or under reduced pressure (S306), and two LCD panels are bonded together (S307). Here, when the pressure is no more than 10000 Pa, air bubbles are not generated and the bonding process may be easily performed. High vacuum environment below 1 Pa is not necessary. Next, in order to temporarily fix the laminated LCD panels, UV light is irradiated on a part of the adhesive to cure temporarily (S308).

Then, in a UV light curing process (S309), in order to completely cure the adhesive, a predetermined amount of UV light is irradiated to the adhesive formed by application from an upper face and a side face of the panel. Because of the light diffusion effect of the light diffusion particles included in the UV light curing adhesive, UV light is irradiated everywhere in the whole adhesive. Further, when a hybrid type (UV curing and heat curing) adhesive is adopted, a heat curing step is added to the UV light curing step of a UV light curing adhesive. In a heat curing step (S309), the adhesive is cured completely at a temperature that does not influence a resin member such as a polarizing plate. Desirable heat curing temperature of the adhesive is 60 to 80 degrees. In view of curing of the adhesive and influence on the resin member such as a polarizing plate, heat-curing temperature is preferably 70 to 75 degrees.

### Second Exemplary Embodiment

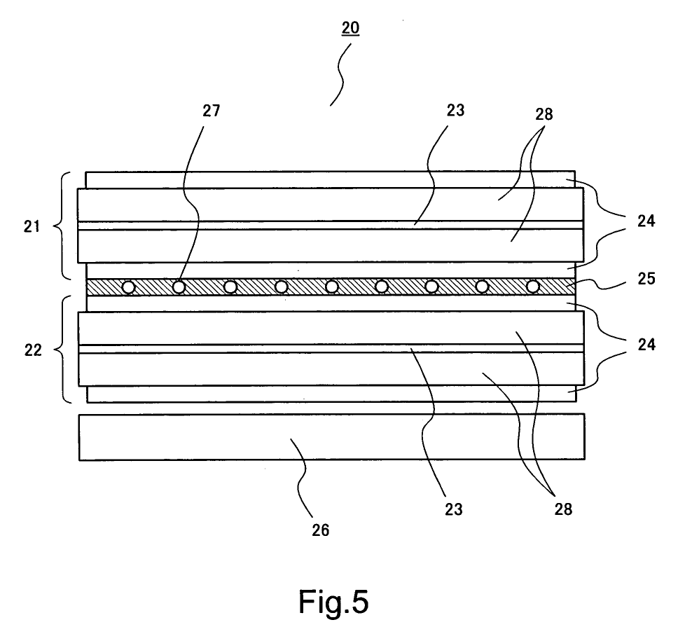

FIG. 5 is a cross sectional view of an LCD device of a second exemplary embodiment. An LCD device 20 includes a first LCD panel 21, a second LCD panel 22 and a backlight source 26. Each of the first and the second LCD panels 21 and 22 includes a pair of transparent substrates 28 facing each other at a predetermined interval and a pair of polarizing plates 24. A liquid crystal material 23 is interposed between the transparent substrates. Each of polarizing plates 24 is arranged on an opposite face of the liquid crystal material 23 on each of transparent substrates 28. The first and the second LCD panels 21 and 22 are bonded together by using an UV light delay curing adhesive 25. The UV light delay curing adhesive 25 includes light diffusion particles 27. At least one of the first and the second LCD panels 21 and 22 may include a color filter layer for a color display. An IPS (In Plane Switching) type is applicable as a display mode of the first and second LCD panel 21 and 22. A backlight source 26 is a display light source of the LCD device 20. The first and the second LCD panels 21 and 22 are bonded so that a position of a pixel on the first LCD panel is fitted to the position of a corresponding pixel on the second LCD panel in a normal direction of the panels.

A light transmission axis or a light absorption axis of the polarizing plate in a light incident side (i.e. a side facing the second LCD panel 22) of the first LCD panel 21 has to be substantially parallel to the light transmission axis or the light absorption axis of the polarizing plate on the light emission side (i.e. a side facing the first LCD panel 21) of the second LCD panel 22. Display operations of the first and the second LCD panels 21 and 22 are controlled based on the same image data.

A UV light delay curing adhesive is transparent and colorless. When a predetermined time elapses after irradiation of UV light, the adhesive rapidly begins to cure, that is, viscosity of the adhesive rapidly increases JP-2006-244978 discloses the adhesive. The adhesive includes an acrylic acid modified epoxy compound as a main photo radical polymerized compound. The material further includes a photo polymerization initiator, a curing regulator, a silane coupling agent, and a heat-curing agent. When a predetermined time elapses after irradiation of UV light, additives, such as the photo polymerization initiator in the adhesive, rapidly react with the acrylic acid modified epoxy compound, and the adhesive rapidly begins to cure. A required time until start of rapid curing is controllable according to an amount of additives, such as the curing regulator. In the heat-curing process after completion of UV light curing, heat-curing of the UV light delay curing adhesive is carried out and curing thereof is promoted. However, curing of the adhesive can be promoted at a low temperature and in a short time. As a curing regulator, a polyglycol compound, such as polyethylene glycol and polyoxy tetramethylene glycol, or a polyalkylene oxide compound are available. Such materials are elastic polymer materials and do not easily deteriorate regardless of change of temperature or pressure. As a result, if the adhesive includes the materials, bond strength increases and adhesion reliability of bonding improves. A film of the UV light delay curing adhesive after curing includes a very high transmissivity. A refractive index of the film is close to the refractive index of a glass substrate. i.e. 1.5. Coefficient of linear expansion of the film is near 8×10⁻⁶ to 9×10⁻⁶/degree which is the coefficient of linear expansion of the glass substrate. The UV light delay curing adhesive is quite excellent as a material arranged between the LCD panels including glass substrates.

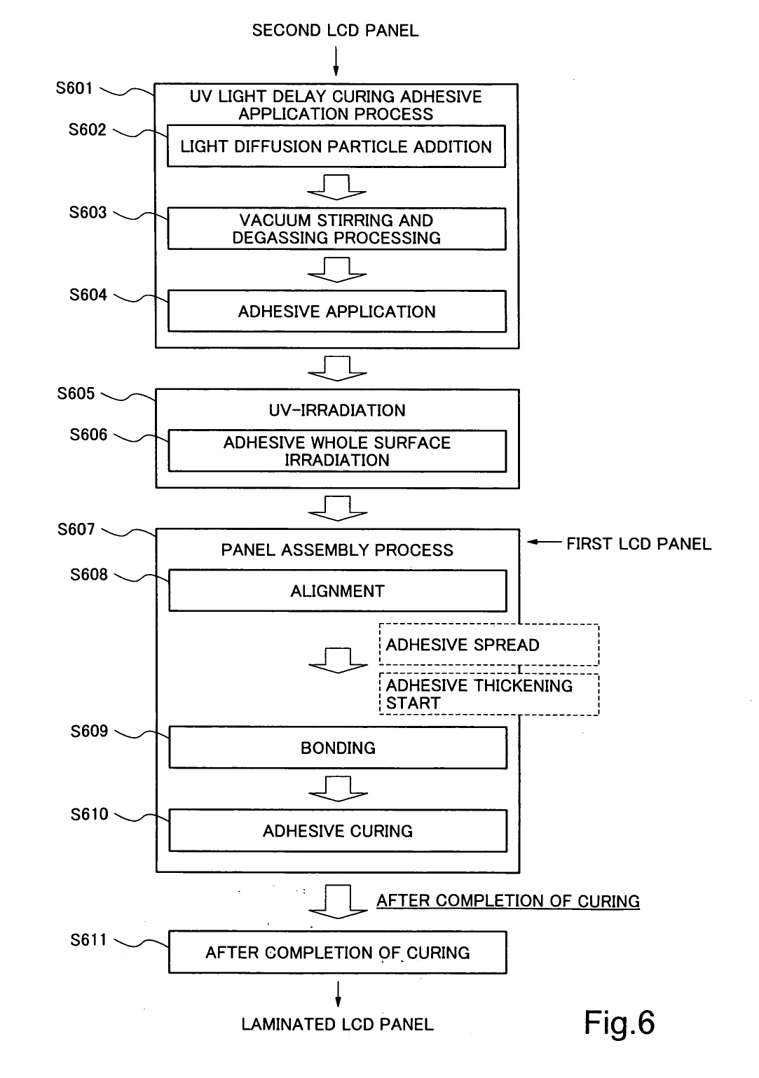

In a manufacturing method of the laminated LCD panels in the second exemplary embodiment, delay curing characteristics of the UV light delay curing adhesive including the light diffusion particles are used. By the manufacturing method, two or more LCD panels for an LCD device are uniformly and firmly bonded to each other with sufficient accuracy. FIG. 6 shows a flow chart of a assembling step of two or more LCD panels as an example of the manufacturing method of the exemplary embodiment.

In the application process of a UV light delay curing adhesive (S601) shown in FIG. 6, a predetermined amount of the light diffusion particles are added in the UV light delay curing adhesive (S602). Next, a stirring and degassing process is performed in vacuum (S603). Thereby, the light diffusion particles are uniformly distributed in the adhesive. Next, a predetermined amount of the adhesive is applied on a surface of a second LCD panel (S604). An amount of the adhesive to be applied is determined according to an area of the LCD panel surface in which the adhesive spreads. Viscosity of the adhesive applied on the display surface is not limited here, but in view of spreading of the adhesive, the viscosity is desirably no more than 5000 mPa second. Further, in view of application stability thereof, more desirable viscosity is 100 to 1000 mPa second. When the viscosity of the adhesive is larger than 5000 mPa second, the adhesive tends to spread non-uniformly. If the viscosity thereof is smaller than 100 mPa second, it becomes difficult to apply the adhesive in a desired shape. FIGS. 4A to 4D show examples of the application shape of the adhesive in the exemplary embodiment. The adhesive is applied on a display surface in a spherical shape (FIG. 4A), a dotted shape (FIG. 4B), a line (FIG. 4C), or a radial shape (FIG. 4D). According to the size of the LCD panel, appropriate application shape is selected.

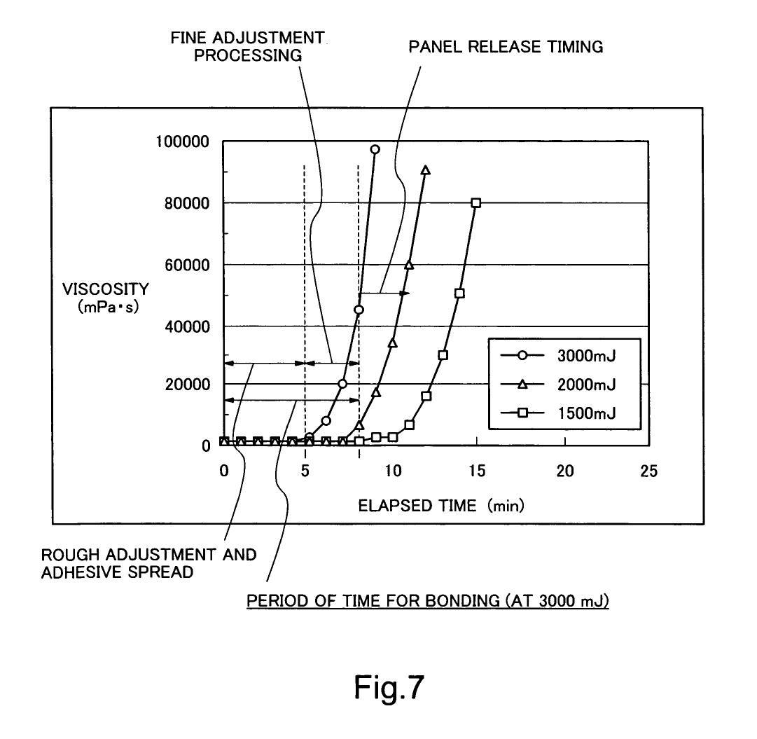

Then, in a UV light irradiation process (S605), a predetermined amount of UV light is irradiated to the applied adhesive (S606). According to the amount of irradiating UV light, a required time until start of rapid curing is controllable. FIG. 7 shows a relation between the viscosity of the UV light delay curing adhesive used in the exemplary embodiment and an elapsed time after UV light irradiation. FIG. 7 shows that a period of time for bonding the LCD panels is controlled based on the amount of irradiating UV light. That is, the longer the period of time for bonding the LCD panels is, the smaller the amount of irradiating UV light is.

Next, in a panel assembly step (S607), the first LCD panel and the second LCD panel are bonded together under atmosphere pressure or under reduced pressure. If the reduced pressure is 10000 Pa or less, it is easy to avoid air bubbles generation and to bond the panels. Reduced pressure below 1 Pa is not necessary. The period of time from the UV light irradiation to an adhesion to bonding of the LCD panels is defined as a period of time for bonding. It is necessary to perform an alignment process (S608) and complete bonding the panels within the period of time for bonding. FIG. 7 shows an example that the adhesive is irradiated with UV light having an amount of irradiation of 3000 mJ. In rough adjustment in the alignment process, the applied adhesive with low or appropriate viscosity spreads on the panel. Next, fine adjustment in the alignment process is performed. Then, spherical light diffusion particles work as lubricants. Therefore, even though viscosity of the adhesive increases, the fine adjustment can be easily performed. Next, the LCD panels are pressed and bonded (S609), when the alignment process is completed. In order to avoid panel misalignment due to own weight of the LCD panel after panel release, the adhesive has to be highly viscous. Desirably, the adhesive viscosity is no smaller than 50000 mPa second. The applied adhesive is spread on the whole display surface areas. The LCD panels are bonded together in a uniform state. The laminated LCD panels are held in a static condition to cure the adhesive by the UV light until the period of time for bonding elapses since completion of bonding (S610).

After completion of the UV light curing, the adhesive is thermally cured for a short time at a temperature which does not influence resin members, such as the polarizing plate in a heat-curing process (S611). The heat-curing process promotes curing of the adhesive, and the curing thereof is finally completed. A preferable heat-curing temperature for the adhesive is 60 to 80 degrees. In view of influence on resin members such as the polarizing plate and of the curing of the adhesive, the heat-curing temperature for the adhesive is 70 to 75 degrees more preferably. Because of the heat-curing with a low temperature and a short curing time, bond strength of the adhesive further increases.

### Third Exemplary Embodiment

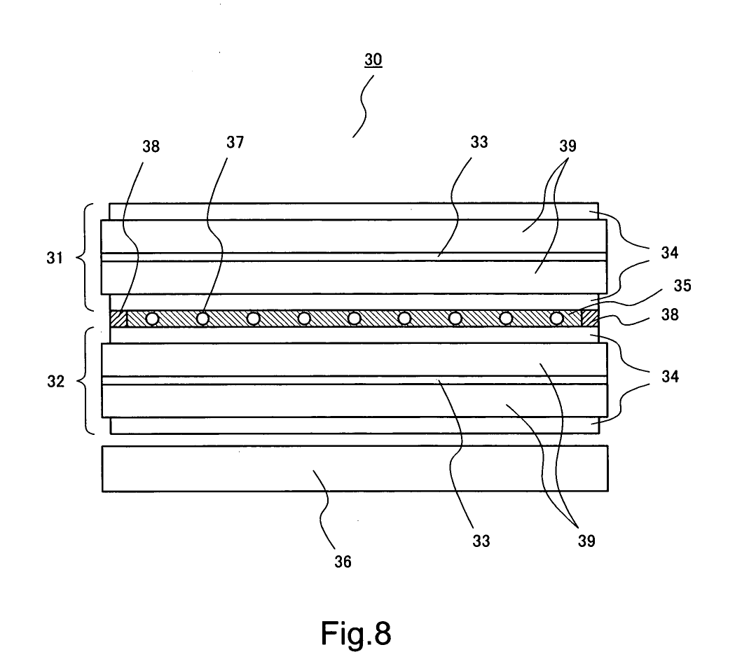

FIG. 8 is a sectional view of an LCD device of a third exemplary embodiment. An LCD device 30 includes a first LCD panel 31, a second LCD panel 32, and a backlight source 36. Each of the first and the second LCD panels 31 and 32 includes a pair of transparent substrates 39 facing each other at a predetermined interval, and a pair of polarizing plates 34. A liquid crystal material 33 is interposed between transparent substrates 39. Each of polarizing plates 34 is arranged on an opposite face of the liquid crystal material 33 on each of transparent substrates 39. The LCD device 30 is formed as follows. A UV light delay curing adhesive with high viscosity 38 is arranged at edge region of a display surface area between the first LCD panel 31 and the second LCD panel 31 so that the adhesive 38 encircles the display surface area. Next, a UV light delay curing adhesive with low viscosity 35 is arranged in an area encircled by the adhesive 38 on the display surface area. The adhesive 35 includes light diffusion particles 37. Viscosity thereof is 100 mPa second to 5000 mPa second. The adhesive with high viscosity 38 surrounding the display surface area prevents the adhesive of low viscosity 35 from running off the edge of laminated LCD panels during bonding the LCD panels. Thereby, margin of variation of an amount of the applied adhesive can be increased. Further, flexibility of applied shapes and positions thereof can be increased.

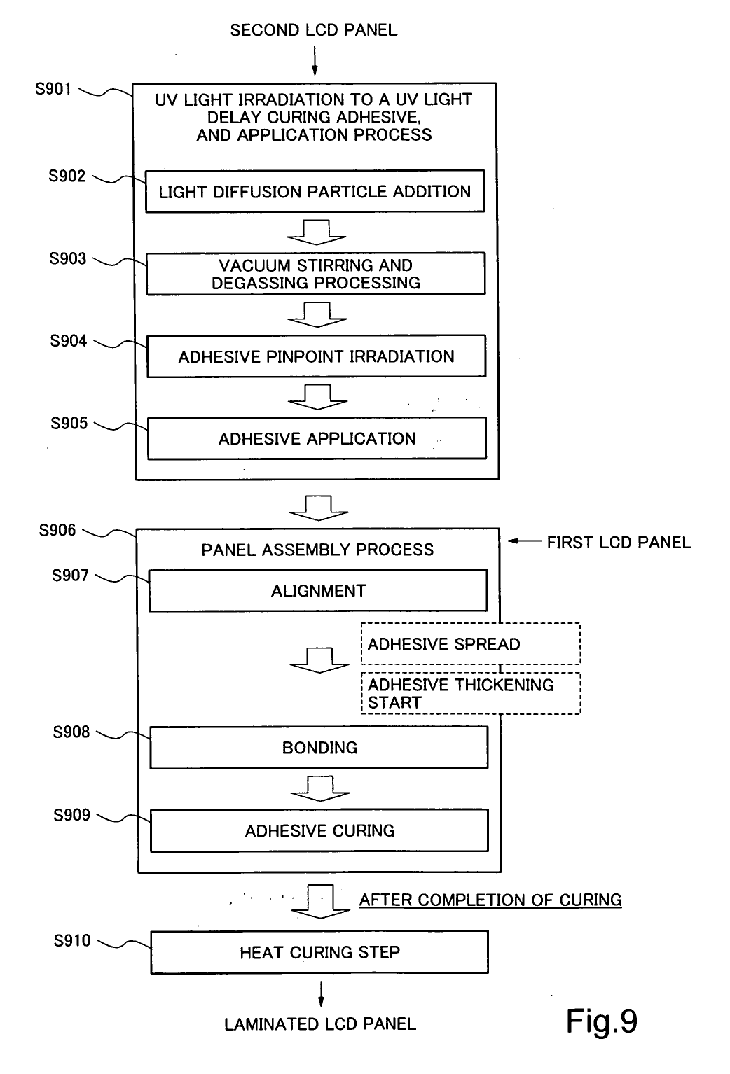

FIG. 9 shows a flow chart of processes of bonding two or more LCD panels, as an example of a manufacturing method of the exemplary embodiment. The viscosity and the curing time of the UV light delay curing adhesive are controlled by irradiating the adhesive with UV light beforehand. In UV light irradiation and application process of the UV light delay curing adhesive shown in FIG. 9 (S901), a predetermined amount of the light diffusion particles are added in the UV light delay curing adhesive (S902). Next, a stirring and degassing process is performed for the adhesive in vacuum (S903), and the light diffusion particles are uniformly distributed therein. Next, the UV light delay curing adhesive is irradiated with a predetermined amount of the UV light (S904). Then, the adhesive is applied continuously (S905). Since only the adhesive is irradiated with the UV light, waste of the UV light irradiation is minimized and efficiency of the UV light irradiation improves. It becomes possible to apply simultaneously two kinds of adhesives with different viscosity, as shown in FIG. 8. Since the adhesive is irradiated with the UV light in advance and since the time from start of a bonding operation to curing of the adhesive is reduced, working hours for a bonding process of the LCD panels are shortened.

Next, in a panel assembly step (S906), the first LCD panel and the second LCD panel are bonded under atmosphere pressure or under reduced pressure. It is necessary to perform an alignment step (S907) and complete bonding in the period of time for bonding. In rough adjustment in the alignment process, the applied adhesive with low or appropriate viscosity spreads on the panel. Next, fine adjustment in the alignment process is performed. Next, the LCD panels are pressed and bonded (S908), when the alignment process is completed. In order to avoid panel misalignment due to own weight of the LCD panel after panel release, the adhesive has to be highly viscous. Desirably, the adhesive viscosity is no smaller than 50000 mPa second. The applied adhesive is spread on the whole display surface areas. The LCD panels are bonded together in a uniform state. The laminated LCD panels are held in a static condition to cure the adhesive by the UV light until the period of time for bonding passes since completion of bonding (S909).

After completion of the UV light curing, the adhesive is thermally cured for a short time at a temperature which does not influence resin members, such as the polarizing plate in a heat-curing process (S910). The heat-curing process promotes curing of the adhesive and finally the curing thereof is completed. A preferable heat-curing temperature for the adhesive is 60 to 80 degrees. In view of influence on resin members such as the polarizing plate and the curing of the adhesive, the heat-curing temperature for the adhesive is 70 to 75 degrees more preferably. Because of the heat-curing with a low temperature and a short curing time, bond strength of the adhesive further increases.

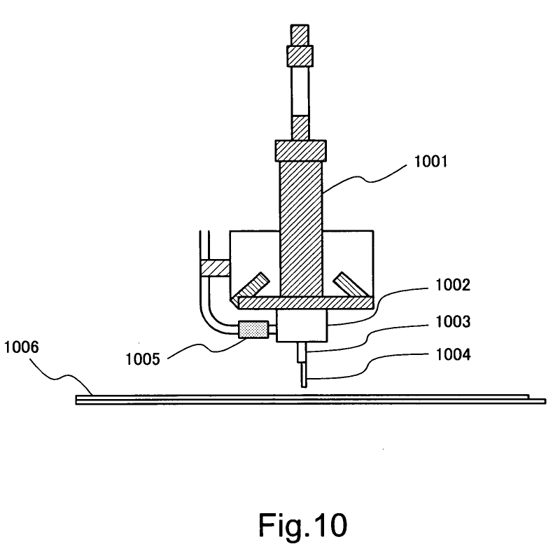

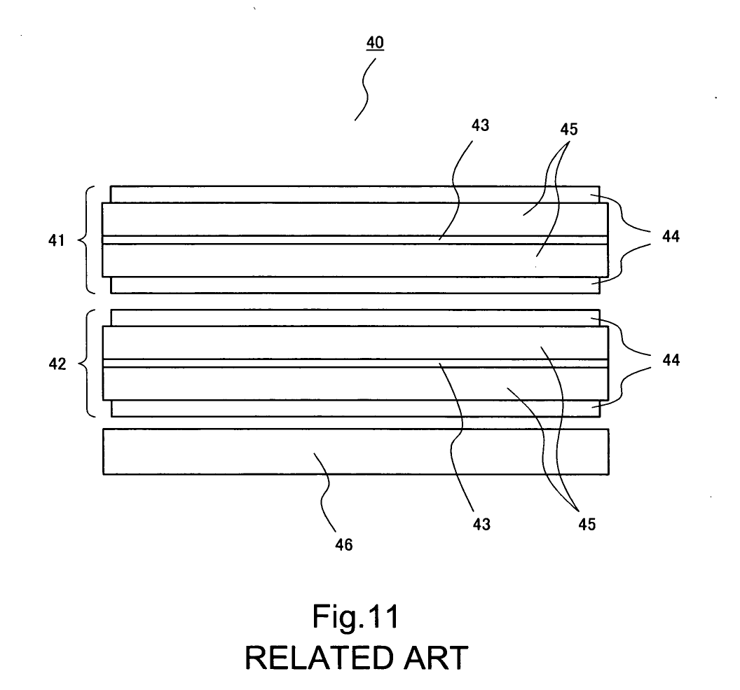

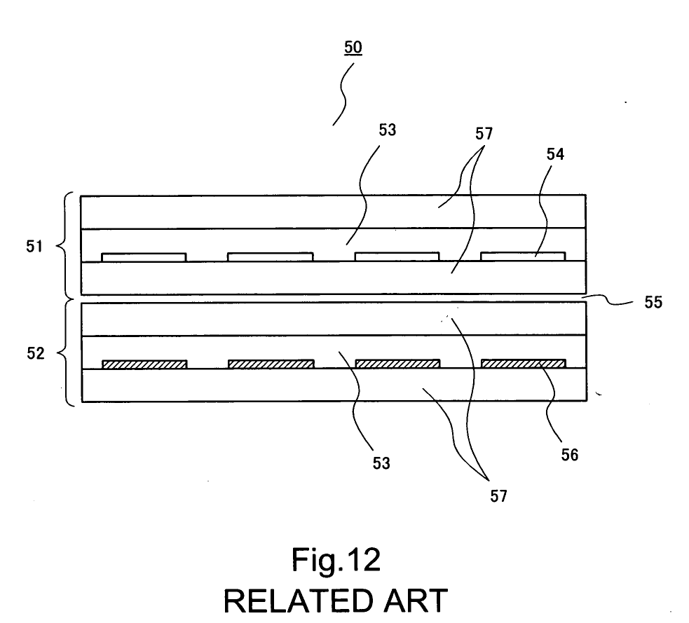

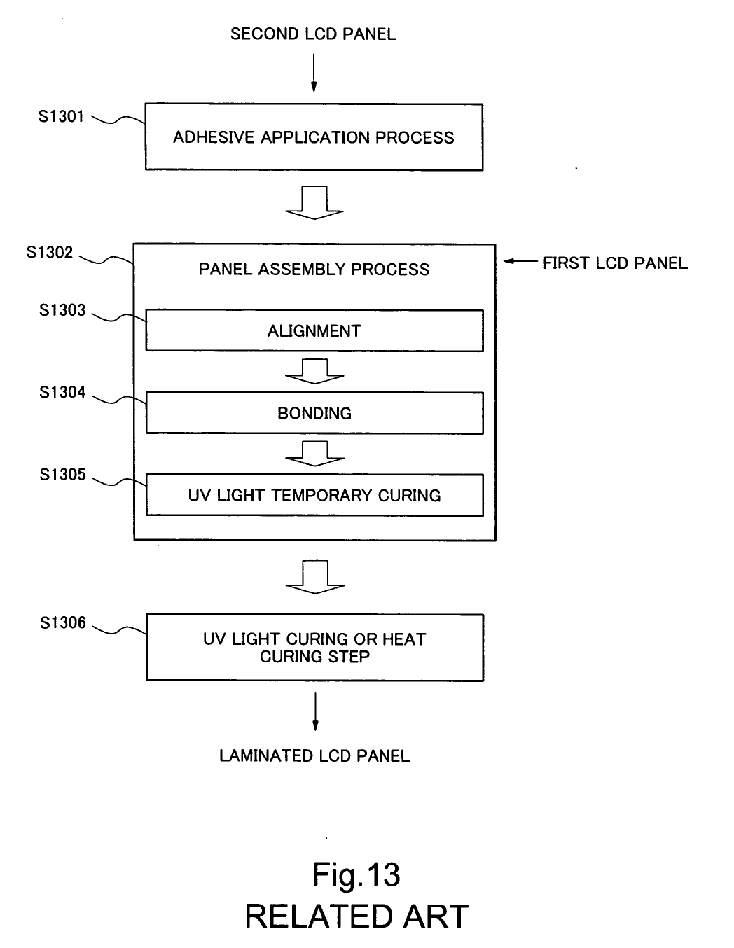

FIG. 10 shows an example of a dispenser device for the UV light delay curing adhesive in the exemplary embodiment. After a specified amount of the UV light delay curing adhesive is accurately irradiated with a predetermined amount of the UV light in advance in the process flow chart shown in FIG. 9, the adhesive is continuously applied to the panel. That is, a required amount of the adhesive for application in the adhesive stored in a syringe 1001 transfers to an application head 1002. In the application head, a predetermined amount of UV light is irradiated to the required amount of the adhesive for application with a UV light lamp 1005. The adhesive irradiated with the UV light is continuously applied to the LCD panel from a nozzle 1003. Since light diffusion particles are added in the UV light delay curing adhesive, the UV light uniformly diffuses inside the adhesive in the application head 1002 due to light diffusion effect. If the dispenser device and a plurality of UV light delay curing adhesives each being irradiated with different UV light irradiation intensity are employed, a UV light delay curing adhesive 1004 having a desired curing rate (time) can be efficiently applied on desired positions of the LCD panel 1006. Further, if a plurality of UV light delay curing adhesives each having a different amount of additive such as a curing regulator are employed, a UV light delay curing adhesive having a desired curing rate (time) can be efficiently applied on desired positions of the LCD panel.

In the above-mentioned description, the examples of the LCD device are described. However, the exemplary embodiment is not limited to the LCD device in which a plurality of LCD panels are bonded, but may be applied to whole display devices. For example, the exemplary embodiments may be applied to a touch-sensitive LCD device, an LCD device with 3D (three-dimensional) lens, organic or inorganic EL (electroluminescence) display, etc. Regarding lenses and films included in the devices which are opaque or shielded, accurate, uniform and firm bonding performance is possible. Further, the light diffusion effect improves display quality.

Hereafter, examples of above-mentioned exemplary embodiments are explained. Unless an outline of the exemplary embodiments is changed, the present invention is not limited to following examples.

### Example 1

A manufacturing method of an LCD device of the first exemplary embodiment is described. In an application step of a UV light curing adhesive, the UV light curing adhesive with viscosity of 1000 mPa second is used. Spherical light diffusion particles having a mean particle size of 20 micrometers are added in the adhesive with an additive amount of 8 weight percent. A vacuum stirring and degassing process is performed for 15 minutes under reduced pressure of 100 Pa using a vacuum stirring and degassing apparatus. Thus, the adhesive in which the light diffusion particles are uniformly distributed is obtained. A predetermined amount of the adhesive is applied on a display surface area of a second LCD panel in a dotted shape with a dispenser device. In a following panel assembly step, a first LCD panel and the second LCD panel are bonded under atmosphere pressure. Alignment steps of rough adjustment and fine adjustment are performed successively. An upper plate having the first LCD panel with a sucker slowly presses the second LCD panel on a lower surface plate with pressure of 500 Newton. After that, the first LCD panel is released from the upper plate to complete bonding. In order to temporarily fix the bonded laminated LCD panels, UV light spot irradiation is performed to eight portions on an edge region of an adhesive forming area on the LCD panel to temporarily cure the adhesive. Then, in a UV light curing step, the applied adhesive is directly irradiated with UV light of an irradiation amount of 6000 mJ from an upper face and a side face of the laminated LCD panel using a stationary type UV lamp. Then, the adhesive is completely cured.

The adhesive formed in the laminated LCD panels which is completely cured with the UV light includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 M/s² are applied ten times to the laminated LCD panels in X, Y, and Z axes directions for one minute. In the high-humidity and high temperature test, the laminated LCD panels are driven for 500 hours at a temperature of 60 degrees and at a humidity of 60 percent. As a result, in each test, the adhesive does not break away from the panel display surface, and displaying state of the laminated LCD panels is excellent.

### Example 2

Another manufacturing method of the LCD device of the first exemplary embodiment is described. In an application process of a UV light curing adhesive, a hybrid type (UV light curing and heat curing) adhesive with a viscosity of 1000 mPa second is employed. Light diffusion particles are added to the UV light curing adhesive by 8 weight percent thereof. Each of the light diffusion particles has an ellipse shape and a mean particle size of 20 micrometers. A vacuum stirring and degassing process is performed for 15 minutes under reduced pressure of 100 Pa using a vacuum stirring and degassing apparatus. Thus, the adhesive in which the light diffusion particles are uniformly distributed is obtained. Next, a predetermined amount of the adhesive including the light diffusion particles is applied in a radial pattern on the display surface area of the second LCD panel using a dispenser device. In a following panel assembly step, the first LCD panel and the second LCD panel are bonded under reduced pressure of 3000 Pa. Rough adjustment and fine adjustment for an alignment step are performed successively. While maintaining contact of an upper plate having the first LCD panel and a lower plate having the second LCD panel, reduced pressure is restored and the panels are released. As a result, the panels are bonded by atmosphere pressure being applied. Since air bubbles are hardly generated, a prolonged pressing treatment is not necessary in the method of bonding under reduced pressure. Therefore, in the method, a lead time in the panel assembly step is shortened compared with that of the first example. After completion of bonding, in order to temporarily fix the laminated LCD panels, UV light spot irradiation is performed to eight portions on an edge region of an adhesive forming area on the LCD panel to temporarily cure the adhesive. Then, in a UV light curing step, an applied adhesive is directly irradiated with UV light of an irradiation amount of 6000 mJ from an upper face and a side face of the laminated LCD panel using a stationary type UV lamp. Then, the adhesive is completely cured. Since elliptical light diffusion particles are used as light diffusion particles added in the adhesive, UV light diffuses effectively inside the adhesive in a shorter time than that of the first example. In a heat curing step, the adhesive is completely cured by heat-treating at 75 degrees.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied ten times to the laminated LCD panels in X, Y, and Z axes directions for one minute. In the high-humidity and high temperature test, the laminated LCD panels are driven for 500 hours at a temperature of 60 degrees and at a humidity of 60 percent. As a result, in each test, the adhesive does not break away from the panel display surface, and displaying state of the laminated LCD panels is excellent.

### Example 3

A manufacturing method of an LCD device of the second exemplary embodiment is described. In an application step of a UV light delay curing adhesive, the UV light delay curing adhesive with a viscosity of 500 mPa second is used. Spherical light diffusion particles having a mean particle size of 10 micrometers are added in the adhesive by 8 weight percent thereof. A vacuum stirring and degassing process is performed for 15 minutes under reduced pressure of 100 Pa using a vacuum stirring and degassing apparatus. Thus, the adhesive in which the light diffusion particles are uniformly distributed is obtained. A predetermined amount of the adhesive is applied on a display surface area of a second LCD panel in a dotted shape with a dispenser device. Then, in a UV light irradiating step, the whole applied adhesive is directly irradiated with UV light of an irradiation amount of 3000 mJ using a stationary type UV lamp. In a following panel assembly step, a first LCD panel and the second LCD panel are bonded under atmosphere pressure. As shown in FIG. 7, a period of time for bonding is 8 minutes. Alignment steps of rough adjustment and fine adjustment are performed successively within the period of time for bonding. An upper plate having the first LCD panel with a sucker slowly presses the second LCD panel on a lower surface plate with a pressure of 500 Newton to bond the first and the second LCD panels. After the period of time for bonding elapses, the first LCD panel is released from the upper plate. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied to the laminated LCD panels in X, Y, and Z axes directions. The vibration is repeated ten times for one minute respectively. In the high-humidity and high temperature test, the laminated LCD panels are driven for 1000 hours at a temperature of 60 degrees and at a humidity of 60 percent. As a result, in each test, the adhesive does not break away from the panel display surface, and displaying state of the laminated LCD panels is excellent.

### Example 4

Another manufacturing method of an LCD device of the second exemplary embodiment is described. In an application step of a UV light delay curing adhesive, the UV light delay curing adhesive with a viscosity of 500 mPa second is used. Spherical light diffusion particles having a mean particle size of 10 micrometers are added in the adhesive by 8 weight percent thereof. A vacuum stirring and degassing process is performed for 15 minutes under reduced pressure of 100 Pa using a vacuum stirring and degassing apparatus. Thus, the adhesive in which the light diffusion particles are uniformly distributed is obtained. A predetermined amount of the adhesive is applied on a display surface area of a second LCD panel in a radial shape with a dispenser device. Then, in a UV light irradiating step, the whole applied adhesive is directly irradiated with UV light of an irradiation amount of 4500 mJ using a stationary type UV lamp. In a following panel assembly step, a first LCD panel and the second LCD panel are bonded under reduced pressure of 3000 Pa. A period of time for bonding is 5 minutes. Alignment steps of rough adjustment and fine adjustment are performed successively within the period of time for bonding. After the period of time for bonding elapses, while maintaining contact of an upper plate having a first LCD panel and a lower plate having a second LCD panel, the reduced pressure is restored and the panels are released. Then, the panels are bonded while being pressed by atmosphere pressure. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied to the laminated LCD panels in X, Y, and Z axes directions. The vibration is repeated ten times for one minute respectively. In the high-humidity and high temperature test, the laminated LCD panels are driven for 1000 hours at a temperature of 60 degrees and at a humidity of 60 percent. As a result, in each test, the adhesive does not break away from the panel display surface, and displaying state of the laminated LCD panels is excellent.

### Example 5

Further manufacturing method of an LCD device of the second exemplary embodiment is described. In an application step of a UV light delay curing adhesive, the UV light delay curing adhesive with a viscosity of 300 mPa second is used. Spherical light diffusion particles having a mean particle size of 5 micrometers are added in the adhesive by 8 weight percent thereof. A vacuum stirring and degassing process is performed for 15 minutes under reduced pressure of 100 Pa using a vacuum stirring and degassing apparatus. Thus, the adhesive in which the light diffusion particles are uniformly distributed is obtained. Next, using a flexographic printing method, the adhesive is uniformly applied to a whole display surface area of a second LCD panel to form a light diffusion adhesive layer thereon. Since the light diffusion adhesive layer having uniform thickness is formed on the LCD panel surface in advance, homogeneity of an amount of UV irradiation onto a face of the adhesive improves. Therefore, homogeneity in the face of the thickening speed (curing rate) of the adhesive also improves, and stable bond strength thereof is obtained. The amount of UV irradiation can be reduced. UV light irradiation time is shortened. In a following UV light irradiation process, the whole applied adhesive is directly irradiated with UV light having a irradiation amount of 4000 mJ using a stationary type UV lamp. In a following panel assembly step, a first LCD panel and the second LCD panel is bonded under reduced pressure of 3000 Pa. The period of time for bonding of the adhesive is 5 minutes. Within the period of time for bonding, an alignment step with rough adjustment and fine adjustment are performed successively. The alignment step is performed after the period of time for bonding passes. While maintaining contact of an upper plate having a first LCD panel and a lower plate having a second LCD panel, the reduced pressure is restored and the panels are released. As a result, the panels are bonded by atmosphere pressure being applied. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied to the laminated LCD panels in X, Y, and Z axes directions. The vibration is repeated ten times for one minute respectively. In the high-humidity and high temperature test, the laminated LCD panels are driven for 1000 hours at a temperature of 60 degree and at a humidity of 60 percent. As a result, in each test, the adhesive does not break away from the panel display surface, and displaying state of the laminated LCD panels is excellent.

### Example 6

A manufacturing method of the LCD device of the third exemplary embodiment is described. In an application step of a UV light delay curing adhesive, the UV light delay curing adhesive having high viscosity of 50000 mPa second and the UV light delay curing adhesive having low viscosity of 300 mPa second are employed. Spherical light diffusion particles having a mean particle size of 10 micrometers are added to the UV light delay curing adhesive having low viscosity by an amount of 5 weight percent thereof. A vacuum stirring and degassing process for 15 minutes is performed for the UV light delay curing adhesive having low viscosity under reduced pressure of 100 Pa using a vacuum stirring and degassing apparatus. The adhesive having low viscosity in which the light diffusion particles are uniformly distributed is obtained. Next, vacuum degassing process for 15 minutes is performed for the UV light delay curing adhesive having high viscosity under reduced pressure. Next, the UV light delay curing adhesive having high viscosity is formed in an edge region of a display surface of the second LCD panel using a dispenser device, so that the adhesive encircles the display surface. A predetermined amount of the UV light delay curing adhesive having low viscosity is applied on the display surface of the second LCD panel in a dotted shape. In a UV light irradiation step, the whole applied adhesive is directly irradiated with UV light of an irradiation amount of 3000 mJ using a stationary type UV lamp. In a following panel assembly step, a first LCD panel and the second LCD panel are bonded under atmosphere pressure. The period of time for bonding is 3 minutes. Alignment steps of rough adjustment and fine adjustment are performed successively within the period of time for bonding. An upper plate having the first LCD panel with a sucker slowly presses the second LCD panel on a lower surface plate with a pressure of 500 Newton to bond the first and the second LCD panels. After the period of time for bonding elapses, the first LCD panel is released from the upper plate. The period of time for bonding of the UV light delay curing adhesive having high viscosity is preferably equal to or shorter than that of the UV light delay curing adhesive having low viscosity. Here, an additive amount of curing regulator to the UV light delay curing adhesive having high viscosity is equal to or less than that to the UV light delay curing adhesive having low viscosity. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied to the laminated LCD panels in X, Y, and Z axes directions. The vibration is repeated ten times for one minute respectively. In the high-humidity and high temperature test, the laminated LCD panels are driven for 1000 hours at a temperature of 60 degrees and at a humidity of 60 percent. As a result, in each test, the adhesive does not break away from the panel display surface, and displaying state of the laminated LCD panels is excellent.

### Example 7

Another manufacturing method of the LCD device of the third exemplary embodiment is described. In an application step of a UV light delay curing adhesive, the UV light delay curing adhesive having high viscosity of 50000 mPa second and the UV light delay curing adhesive having low viscosity of 300 mPa second are employed. Spherical light diffusion particles having a mean particle size of 10 micrometers are added to the UV light delay curing adhesive having low viscosity by an amount of 5 weight percent thereof. A vacuum stirring and degassing process for 15 minutes is performed for the UV light delay curing adhesive having low viscosity under reduced pressure of 100 Pa using a vacuum stirring and degassing apparatus. The adhesive having low viscosity in which the light diffusion particles are uniformly distributed is obtained. Next, a vacuum degassing process for 15 minutes is performed for the UV light delay curing adhesive having high viscosity under reduced pressure. Next, the UV light delay curing adhesive having high viscosity is formed in an edge region of a display surface on the second LCD panel using a dispenser device, so that the adhesive encircles the display surface. A predetermined amount of the UV light delay curing adhesive having low viscosity is applied on the display surface of the second LCD panel in a dotted shape. In a UV light irradiation step, the adhesives are irradiated with UV light using a stationary type UV lamp. The UV light delay curing adhesive having high viscosity formed in the edge region of the display surface of the second LCD panel is irradiated by UV light of an irradiation amount of 6000 mJ. The UV light delay curing adhesive having low viscosity applied on the display surface of the second LCD panel in the dotted shape is irradiated by UV light of an irradiation amount of 3000 mJ. Here, an additive amount of curing regulator to the UV light delay curing adhesive having high viscosity is substantially equal to that to the UV light delay curing adhesive having low viscosity. In a following panel assembly step, a first LCD panel and the second LCD panel are bonded under atmosphere pressure. A period of time for bonding of the UV light delay curing adhesive having high viscosity is 2 minutes. Alignment steps of rough adjustment and fine adjustment are performed successively within the period of time for bonding. An upper plate having the first LCD panel with a sucker slowly presses the second LCD panel on a lower surface plate with a pressure of 500 Newton to bond the first and the second LCD panels. After the period of time for bonding elapses, the first LCD panel is released from the upper plate. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s² are applied to the laminated LCD panels in X, Y, and Z axes directions. The vibration is repeated ten times for one minute respectively. In the high-humidity and high temperature test, the laminated LCD panels are driven for 1000 hours at a temperature of 60 degrees and at a humidity of 60 percent. As a result, in each test, the adhesive does not break away from the panel display surface, and displaying state of the laminated LCD panels is excellent.

### Example 8

A manufacturing method which is another process flow of the LCD device of third exemplary embodiment is described. In an application step of a UV light delay curing adhesive, the UV light delay curing adhesive having a viscosity of 500 mPa second. Spherical light diffusion particles having a mean particle size of 10 micrometers are added in the adhesive by 5 weight percent thereof. A vacuum stirring and degassing process is performed for 15 minutes under reduced pressure of 100 Pa using a vacuum stirring and degassing apparatus. Thus, the adhesive in which the light diffusion particles are uniformly distributed is obtained. The adhesive is applied on a display surface area of an LCD panel using a dispenser device for the UV light delay curing adhesive. The applied adhesive is irradiated by UV light of an irradiation amount of 3000 mJ. After that, the adhesive is applied on the display surface area in a dotted shape successively.

In a panel assembly step, a first LCD panel and a second LCD panel are bonded under reduced pressure of 3000 Pa. The period of time for bonding is 5 minutes. Alignment steps of rough adjustment and fine adjustment are performed successively within the period of time for bonding. After the period of time for bonding elapses, while maintaining contact of an upper plate having the first LCD panel and a lower plate having the second LCD panel, the reduced pressure is restored and the panels are released. As a result, the panels are bonded while being pressed by atmosphere pressure. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles and uniformly bonds the LCD panels. The laminated LCD panels do not show the moiré phenomenon which causes deterioration of display quality. A vibration test and a high-humidity and high temperature test are performed to the laminated LCD panels. In the vibration test, vibrations having frequency of 5 to 100 Hz and acceleration of 11.76 m/s2 are applied to the laminated LCD panels in X, Y, and Z axes directions. The vibration is repeated ten times for one minute respectively. In the high-humidity and high temperature test, the laminated LCD panels are driven for 1000 hours at a temperature of 60 degrees and at a humidity of 60 percent. As a result, in each test, the adhesive does not break away from the panel display surface, and displaying state of the laminated LCD panels is excellent.

### Comparative Example 1

For comparison, the UV light delay curing adhesive having a viscosity of 500 mPa second without light diffusion particles is used in an application process of the UV light delay curing adhesive. Laminated LCD panels are manufactured by using the adhesive as follows. A vacuum stirring and degassing process is performed for 15 minutes under reduced pressure of 100 Pa using a vacuum stirring and degassing apparatus. A predetermined amount of the adhesive is applied on a display surface area of a second LCD panel in a radial shape with a dispenser device. In a UV light irradiation step, the whole applied adhesive is directly irradiated with UV light of an irradiation amount of 4500 mJ using a stationary type UV lamp.

In a following panel assembly step, a first LCD panel and the second LCD panel are bonded under reduced pressure of 3000 Pa. A period of time for bonding is 5 minutes. Alignment steps of rough adjustment and fine adjustment are performed successively within the period of time for bonding. After the period of time for bonding elapses, while maintaining contact of an upper plate having the first LCD panel and a lower plate having the second LCD panel, the reduced pressure is restored and the panels are released. As a result, the panels are bonded due to pressurization by atmosphere pressure being applied. After completion of bonding, the laminated LCD panels are held in a static condition to complete the UV light curing until sufficient time elapses. Next, in a heat curing step, the laminated LCD panels are held in a heat-curing device having an inner temperature of 75 degrees for 30 minutes. Then UV light curing of the adhesive is promoted.

The adhesive formed in the laminated LCD panels which is completely cured by the heat curing includes no air bubbles. However, thickness of the adhesive between the LCD panels becomes uneven. A gap between the panels is also uneven. Further, the moiré phenomenon occurs in a displaying state. Because of interference produced between the laminated LCD panels in an oblique view, display quality is degraded. The vibration test and the high-humidity and high temperature test are performed to the laminated LCD panels of the comparative example. The adhesive breaks away from the panel display surface at an uneven portion (e.g. very thin portion) of the adhesive. Further, reliability of the laminated LCD panels is degraded.

The related art described in the background art causes the following problem.

In a manufacturing process for bonding whole faces of the LCD panels each other using a common UV light curing type adhesive, the adhesive is applied on one face of the panel, the panels are bonded, and after that the adhesive is cured by UV irradiation. However, the LCD panel is partially shielded by a polarizing plate, a frame black matrix (BM) of a color filter substrate or the like. Thus, it is difficult to cure the whole adhesive between the liquid crystal display panels. That is, since curing of the adhesive is insufficient in a display area of the laminated LCD panel, bond strength between the LCD panels is low.

JP-11-95246 discloses use of a transparent adhesive for bonding LCD panels. The LCD panel does not include a polarizing plate, but includes light shielding portions such as a pixel electrode and a reflection electrode therein. Therefore, the bond strength of the adhesive cured by UV irradiation is insufficient.

Even when a hybrid type adhesive is used instead of the UV light curing adhesive, curing of the adhesive in the display area of the laminated LCD panel is insufficient in a UV light curing step. Therefore, even if heat treatment is finally performed in a heat curing step, required bond strength cannot be obtained.

JP-2006-244978 discloses bonding using a UV light delay curing adhesive so that LCD panels partially including shielded portions may be bonded. The UV light delay curing adhesive resolves the problem of insufficiency of the bond strength due to insufficient curing. However, it is difficult to keep a gap between the LCD panels constant. When the gap between the LCD panels is not constant, thin parts in the adhesive may be detached during a reliability test. Moreover, a display quality level of the laminated LCD panel partially deteriorates. Therefore, it is difficult to resolve all the problems only by the method disclosed in JP-2006-244978.

According to the examples of the invention, following advantages are obtained. When LCD panels are bonded together and fixed, light diffusion effect characteristics of the UV light curing adhesive containing the light diffusion particles are utilized. According to the examples of the invention, the gap between the LCD panels can be made thin and uniform. Misalignment of the LCD panels does not occur. As a result, even if the LCD panel includes shielded portions, such as BM and a polarizing plate, the panels can be bonded accurately, uniformly and firmly. Interference fringe due to displacement of pixels is not generated. Further, delamination of the LCD panels due to shortage of bond strength between the LCD panels is not generated. The light diffusion particles in the adhesive can prevent the moiré phenomenon, which is degradation of display quality due to interference which occurs between the laminated LCD panels in an oblique view. The LCD device of the invention includes advantages such as an excellent display quality, high reliability and high contrast.

The precious description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A display device, comprising:
a first display device;
a second display device bonded to said first display device; and
an adhesive provided between said first display device and said second display device to fix said first display device on said second display device, and including a light diffusion particle.

2. The display device according to claim 1, wherein
said light diffusion particle includes polymer material including methyl methacrylate polymer.

3. The display device according to claim 1, wherein
said light diffusion particle in said adhesive ranges from 1 to 10 weight percent.

4. The display device according to claim 1, wherein
said light diffusion particle includes at least one of a spherical, an elliptical or a needle-like shape.

5. The display device according to claim 1, wherein
a mean particle diameter of said light diffusion particle ranges from 2 to 50 micrometers.

6. The display device according to claim 1, wherein
said adhesive includes an ultraviolet (UV) light delay curing characteristics.

7. The display device according to claim 6, wherein
said ultraviolet light (UV) delay curing resin includes an acrylic acid modified epoxy compound as a photo radical polymerized compound.

8. The display device according to claim 1, wherein
said adhesive includes a heat curing characteristic.

9. The display device according to claim 8, wherein
said adhesive is formed by heat curing at a temperature ranging from 60 to 80 degrees C.

10. A manufacturing method of a display device, comprising:
bonding a first display device with a second display device disposing an adhesive therebetween; and
curing said adhesive by ultraviolet (UV) light irradiation, said adhesive including a light diffusion particle.

11. The manufacturing method of a display device according to claim 10, wherein
at least one of said first display device and said second display device is ultraviolet (UV) light transmissive, and
said adhesive is cured by irradiating said first display device or said second display device with an ultraviolet (UV) light after bonding said first display device with said second display device.

12. The manufacturing method of a display device according to claim 10, wherein
said light diffusion particle includes polymer material including methyl methacrylate polymer.

13. The manufacturing method of a display device according to claim 10, wherein
said light diffusion particle in said adhesive ranges from 1 to 10 weight percent.

14. The manufacturing method of a display device according to claim 10, wherein
said light diffusion particle includes at least one of a spherical, an elliptical or a needle-like shape.

15. The manufacturing method of a display device according to claim 10, wherein
a mean particle diameter of said light diffusion particle ranges from 2 to 50 micrometers.

16. The manufacturing method of a display device according to claim 10, wherein
said adhesive includes an ultraviolet light delay curing resin, and
said first display device and said second display device are bonded after irradiating an ultraviolet (UV) light to said adhesive.

17. The manufacturing method of a display device according to claim 16, wherein
said ultraviolet (UV) light is irradiated to said adhesive, after said adhesive is formed on said second display device.

18. The manufacturing method of a display device according to claim 16, wherein
said adhesive is formed on said second display device, after said ultraviolet (UV) light is irradiated to said adhesive.

19. The manufacturing method of a display device according to claim 16, wherein
said ultraviolet light (UV) delay curing resin includes an acrylic acid modified epoxy compound as a photo radical polymerized compound.

20. The manufacturing method of a display device according to claim 16, wherein
a first adhesive is applied to an edge portion of a display surface area between said first display device and said second display device, and a second adhesive is applied to said display surface area, said second adhesive having a viscosity lower than a viscosity of said first adhesive.

21. The manufacturing method of a display device according to claim 20, wherein
said a viscosity of second adhesive is not more than 5000 mPa second.

22. The manufacturing method of a display device according to claim 10, wherein
said adhesive includes a thermosetting characteristic.

23. The manufacturing method of a display device according to claim 24, wherein
said adhesive is formed by heat curing at a temperature ranging from 60 to 80 degrees C.

24. A dispenser device for applying an adhesive including an ultraviolet light delay curing resin, comprising:
a storing container to store said adhesive;
an application head to store said adhesive transferred from said storing container;
an ultraviolet (UV) light irradiation lamp to irradiate said ultraviolet (UV) light to said adhesive stored in said application head; and
a nozzle to eject and applying said adhesive irradiated with said ultraviolet (UV) light.
